(19) United States
(12) Patent Application Publication
(10) Pub. No.: US 2005/0109138 A1
(43) Pub. Date: May 26, 2005

(54) Inertial propulsion drive

(76) Inventor: Harold Ariel Tavarez, Long Beach, CA (US)

Correspondence Address: Harold Tavarez, 2501 East 4th Street #2, Long Beach, CA, 90814, US

(21) Appl. No.: 10/720,768

(22) Filed: Nov. 24, 2003

(51) Int. Cl. F16H 27/04

(52) U.S. Cl. 74/84 S

(57) ABSTRACT

An inertial thrust drive (10) comprising a centrifugal thrust generator (12) that comprises a first motor (14); with a weighted arm (16) comprising a radial arm (18) and a weight (20); a platform (22), a second motor (24); the entire assembly mounted on a thrust mount (26). The motor (14) rotates the weighted arm (16) in a counterclockwise rotational direction (30) to generate unbalanced centrifugal forces in its plane of rotation. The centrifugal thrust generator (12) is supported by the platform (22). The platform (22) rotates the thrust generator (12) in a clockwise direction of rotation (32) opposite to the arm (16) rotational direction (30). Both, the first motor (14) and the second motor (24) rotate about a common central axis (34). To generate a directional propulsion force (36), the weighted arm (16) generates unbalanced centrifugal forces in its plane of rotation; and the platform (22) rotates the thrust generator (12) in the opposite direction to maintain the arm (16) pointing in the same direction. The synergy of superimposing the rotational energy of the platform (22) on the thrust generator (12) generates a directional propulsion force (36). The propulsion force (36) vector is useful as a source of thrust for propellantless propulsion.

### BACKGROUND

1. Field of Invention

The present invention employs unbalanced centrifugal forces to generate a propellantless propulsion force.

2. Description of Prior Art

A good deal of the existing propulsion technology is based on the acceleration of a propellant. In jet propulsion, a jet engine accelerates a mass of air from the atmosphere, or a mass of water in a marine environment. Similarly, a propeller accelerates either a mass of air or water to generate thrust. In rocket propulsion, a rocket engine also employs a propellant. In electric, plasma and ion propulsion engines, atomic particles and molecules are the propellant. As dominant and useful the technology is; all these propulsion engines suffer from many serious disadvantages and limitations connected to a dependence on the propellant available for thrust.

In the field of propulsion, one area working towards a propellantless engine is the field of invention utilizing centrifugal forces. By rotating the mass of a body at high speed, considerable amounts of centrifugal forces develop specifically useful as a source of thrust for propulsion. Several propulsion devices and methods have been proposed to generate unidirectional thrust with centrifugal forces. One propulsion method consists of exchanging masses between counter rotating arms. The exchange of masses generates directed and unbalanced centrifugal forces on one side of the propulsion device. Other methods consist of rotating about a main shaft a set of swingable shafts, gears, and weighted arms. Various machines and mechanisms employing these means and methods have been proposed. However, all these means and methods for generating unidirectional and unbalanced centrifugal forces also have many serious disadvantages and limitations. The propulsion devices these means and methods produce are exceedingly complex mechanisms. They require a multiplicity of weighted arms, masses, gears, and swingable shafts to produce the unbalanced centrifugal forces that generate propulsion. Moreover, all the proposed thrust machines fail to generate a continuous and unidirectional thrust of a constant magnitude. At best, all the devices can do is generate a discontinuous impulse of thrust in an unreliable operation with unwanted vibrations. The discontinuous impulse of thrust is predetermined by the degree of separation between the multiplicity of rotating shafts, gears, weighted arms and masses that generate the unbalanced centrifugal forces. As a result of this approach, the propulsion engines constructed accordingly fail to generate a continuous propulsion force of constant magnitude. In addition, the propulsion devices suggested above have not yet found any practical, useful and successful application in the field of propulsion.

### SUMMARY OF THE INVENTION

In the field of propulsion, a propellantless thrust engine is a most useful and desirable prime mover. The present invention is a prime mover employing unbalanced centrifugal forces to generate a continuous and unidirectional propulsion force. The invention employs an orbital mass in the distal end of a radial arm to generate unbalanced centrifugal forces, and a rotating platform to redirect all the unbalanced centrifugal forces in one direction. The redirecting action on the centrifugal forces generates a continuous propulsion thrust vector of constant magnitude. The overall outcome of this approach is a directed centrifugal force vector specifically useful as a source of thrust for propellantless propulsion. The invention is useful as a prime mover for the propulsion of railway cars, passenger cars, trucks, aviation, naval ships, spacecrafts, and satellites.

### BRIEF DESCRIPTION OF THE DRAWINGS

FIG. 1 shows an inertial thrust drive generating a directional propulsion force by using as a source the unbalanced centrifugal forces produced with the orbital mass in a weighted arm.

FIG. 2 shows a centrifugal thrust generator rotating an orbital mass in a radius of gyration to generate an unbalanced centrifugal force useful for propulsion.

FIG. 3A shows a centrifugal thrust generator rotating an orbital mass to generate unrestrained and unbalanced centrifugal forces in all directions in the plane of rotation.

FIG. 3B shows the centrifugal thrust generator revectoring all the unbalanced centrifugal forces in one direction to generate a single unidirectional propulsion force vector.

FIG. 4 and FIG. 5 show how revectoring changes the orientation of the propulsion force vector from one direction to another.

### OPERATION

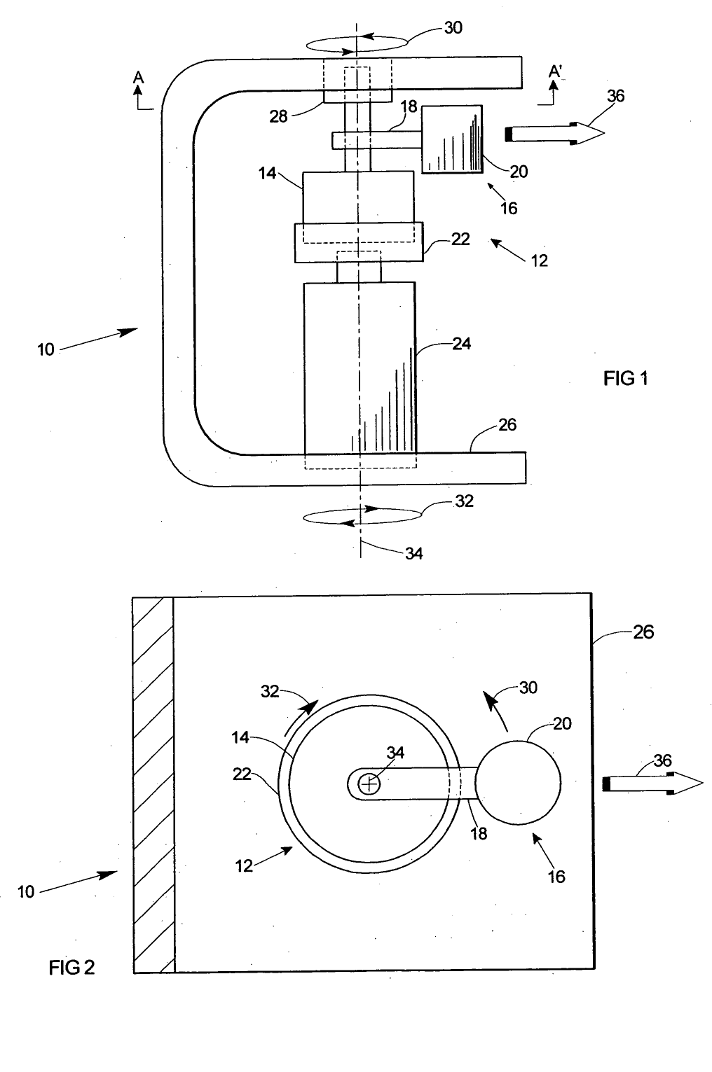

FIG. 1 shows an inertial thrust drive 10 generating a propulsion force 36. The inertial thrust drive 10 has a centrifugal thrust generator 12 with a motor 14 and a weighted arm 16. The weighted arm 16 is a radial arm 18 with a weight 20 on a distal end. The other end of the arm 16 is mounted on the shaft of the motor 14. The arm 16 is mounted to the shaft of the motor 14 with suitable means of attachment, including the use of a single or a plurality of set screws (not shown) to hold the arm 16 on the shaft of the motor 14. The assembled thrust generator 12 is mounted on a platform 22 with suitable means of attachment to hold it in place. Similarly, the platform 22 is mounted on the shaft of a motor 24. The motor 24 is mounted on a thrust mount 26 and held in place with suitable means of attachment. The shaft of the motor 14 extends into a bearing 28. Both motors 14 and 24 have in common a central axis 34. The shaft of first motor 14 rotates the weighted arm 16 in a rotational direction 30 to generate unbalanced centrifugal forces in the arm 16 plane of rotation. The second motor 24 rotates the platform 22 together with the thrust generator 12 in a rotational direction 32. With respect to each other, both, the arm 16 and the platform 22 rotate in the opposite directions 30 and 32 about the axis 34 to generate the unidirectional propulsion force 36. The entire assembly is mounted on a thrust mount 26. The assembled inertial thrust drive 10 can be mounted on the frame of a vehicle, not shown, to generate motion in the direction of the propulsion force 36.

In general, a motor, as employed in the invention, refers to any suitable source of torque such as an electric motor, an internal combustion engine, hydraulic, pneumatic, a turbine, or any combination thereof that will permit the construction and operation of the inertial propulsion engine disclosed as the invention.

FIG. 2 is a view of the inertial thrust drive 10 taken along the line AA′ in FIG 1. In FIG. 2, the common axis of rotation, the central axis 34 is shown with a cross. The motor 14 rotates the weighted arm 16 counterclockwise in the rotational direction 30; while the platform 22 that includes the centrifugal thrust generator 12 rotates in the opposite clockwise rotational direction 32. The function of the platform 22 is to provide an operational link between the motors 14 and 24. The platform 22 counter rotate the thrust generator 12 in order to focus and redirect in one direction the unbalanced centrifugal forces produced with the weighted arm 16. The effect of superimposing the rotation of the platform 22 on the thrust generator 12 is the unidirectional propulsion force 36.

Referring to FIGS. 1 and 2, to generate the unidirectional propulsion force 36, two operations take place simultaneously. In the first operation, the centrifugal thrust generator 12 rotates the weighted arm 16 at a selected angular velocity in the rotational direction 30. As the arm 16 rotates, it generates unbalanced centrifugal forces in all directions in its plane of rotation. In the second operation, the shaft of the motor 24 rotates the platform 22 together with the thrust generator 12 in the opposite direction 32. The magnitude of all the unbalanced centrifugal forces produced by the arm 16 are in proportion to the radius of the arm 18, the mass of the weight 20, and the square of the angular velocity about the axis 34. The unbalanced centrifugal forces produced by the arm 16 are the source of inertial thrust that generates the directional and propellantless propulsion force 36. When both, the thrust generator 12 in the platform 22 and the weighted arm 16 rotate in the opposite directions 30 and 32 with respect to each other, and with the same selected angular velocity, a continuous and unidirectional propulsion force 36 of constant magnitude and direction is the result. The directional thrust achieved with the propulsion force 36 is accomplished by revectoring. Revectoring is a dynamic process or a method that redirects all the unbalanced centrifugal forces in one direction.

Revectoring is accomplished by superimposing the operation of the motor 24 on the operation of the thrust generator 12. The operation of the thrust generator 12 consists of producing unbalanced centrifugal forces with the weighted arm 16. The motor 24 provides the torque to rotate the platform 22 with the thrust generator 12. As the thrust generator 12 rotates in the direction 32; the motor 14 simultaneously rotates the weighted arm 16 in the opposite direction 30 to generate unbalanced centrifugal forces in the arm 16 plane of rotation. In this fashion, revectoring concentrates all the unbalanced centrifugal forces diffused in the arm 16 plane of rotation and focus the unbalanced forces in one direction to generate the propulsion force 36. The phenomenon of unidirectional revectoring occurs by superimposing the rotation of the platform 22 on the rotation of the weighted arm 16 when both, the platform 22 with the generator 12, and the arm 16 rotate with the same selected angular velocity magnitude in opposite directions. Thus, revectoring directs and focus in one direction all the unbalanced centrifugal forces produced by the weighted arm 16.

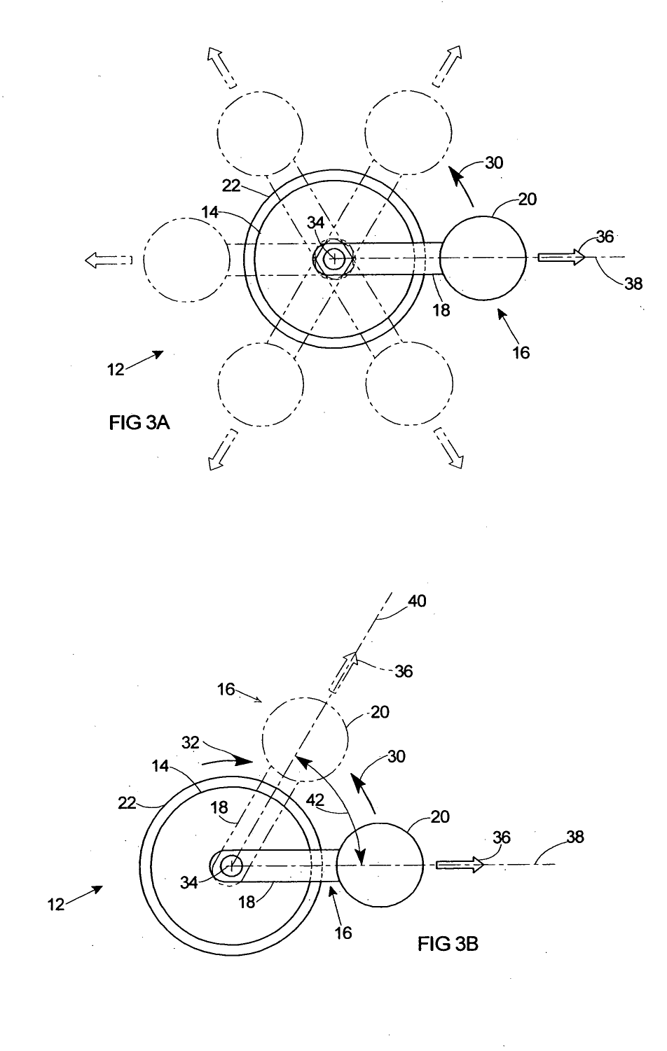

In general, revectoring is a dynamic operation that changes the direction of the unbalanced centrifugal forces by simultaneously turning the thrust generator 12 assembly in a direction opposite to the arm 16 direction of rotation. The efficiency and focusing action of revectoring augment the magnitude of the unbalanced centrifugal forces produced with the arm 16. All the unbalanced centrifugal forces become focused and redirected in one single direction, the direction shown with the vector of the propulsion force 36. Revectoring is further expanded with the explanation given in FIGS. 3A and 3B. In the schematics of FIGS. 3A and 3B, two hypothetical axes 38 and 40, perpendicular to the central axis 34 has been added.

FIG. 3A shows only the centrifugal thrust generator 12 mounted on the platform 22. The thrust generator 12 rotates the weighted arm 16 counterclockwise in the rotational direction 30. As the arm 16 rotates, the platform 22 does not receive any torque input from the shaft of the motor 24 (the motor 24 is best shown in FIG. 1). Hence the motor 24, by way of the platform 22 cannot redirect the unbalanced centrifugal forces produced with the arm 16. Instead, the arm 16 generates unbalanced centrifugal forces in all directions in its plane of rotation as shown in the drawing. Starting and ending on the axis 38, for one cycle of revolution, the motor 14 applies a torque on the radial arm 18 to spin the weight 20 in a circular orbit about the central axis 34. As the weight 20 gyrates, it generates unbalanced centrifugal forces in all directions in its plane of rotation about the axis 34. The alternations of the arm 16 at different positions in its plane of rotation and the unbalanced centrifugal forces are shown with phantom lines. The rotational direction 32 does not appear in FIG. 3A given that, the motor 24 does not provide a torque input to the platform 22. In the same way, if the motor 14 is un-powered and the motor 24 is powered; the motor 24 will exert a torque on the platform 22 that will also rotate the assembly of the thrust generator 12. The arm 16 will also rotate with the generator 12 to generate unbalanced centrifugal forces in its plane of rotation just as before.

However, in order to redirect all the unbalanced centrifugal forces that generate the directional propulsion force 36 through revectoring; the platform 22 will have to gyrate the thrust generator 12 about the axis 34 in the rotational direction 32; a direction of rotation opposite to the weighted arm 16 rotational direction 30. By superimposing the rotation of the platform 22 on the thrust generator 12 and thus the arm 16, a means is provided to control the direction on which all the unbalanced centrifugal forces that make up the propulsion force 36 can be directed as explained with FIG. 3B.

FIG. 3B explains revectoring in more detail; it is assumed that both, the generator 12 and the platform 22 rotate with the same selected angular velocity magnitude in the opposite directions 30 and 32. Starting at the stationary axis 38, in any given period of time, the motor 14 rotates the weighted arm 16 in the direction 30. Without the motor 24 torque acting on the platform 22 in a selected period of time, the arm 16 would travel a finite angular distance away from the axis 38 to the arbitrary position marked with the axis 40. The displacement distance is indicated with an angle 42. The temporal position for the arm 16 is shown with phantom lines. However, simultaneously, the torque of the motor 24 also acts on the platform 22. to rotate the entire thrust generator 12 in the opposite direction 32. In the same period of time, the platform 22 simultaneously rotates the thrust generator 12 to return the arm 16 to the initial starting position on the axis 38. In other words, the counter rotation of the platform 22 keeps the arm 16 in the same relative position. As the arm 16 rotates in the direction 30, the platform 22 rotates the entire thrust generator 12 with the arm 16 in the opposite direction 32. As a result of this revectoring operation, the net angular displacement is zero and the apparent end result is a stand off for the weighted arm 16. Although both, the platform 22 and the arm 16 simultaneously rotate with the same magnitude of angular velocity in the opposite directions 30 and 32, in relation to an observer in an external frame of reference, the arm 16 appears motionless as if it were standing still in one place. To an observer standing in the platform 22 frame of reference, the observer also rotates together with the platform 22 in the same direction with the same speed and phase of synchronization. The observer in the platform 22 will see the arm 16 rotating in the direction 30. To that observer, a point on the platform 22 and on the motor 14 will appear stationary. On the other hand, to the observer in the platform 22, the weight 20 on the distal end of the arm 16 will appear to gyrate in orbit about the axis 34 in the rotational direction 30. In contrast to the observer on the platform 22, to a stationary observer outside the system, the platform 22 and the motor 14 in the thrust generator 12 will appear to rotate about the axis 34 in the rotational direction 32. To the outside observer, the weighted arm 16 will appear stationary and motionless as the result of superimposing the rotation of the platform 22 on the thrust generator 12 and the arm 16. In every cycle of revolution, the weighted arm 16 rotates a full 360° in the direction 30. While simultaneously, the platform 22 rotates the entire thrust generator 12 in the opposite direction 32 with the same speed of rotation. In this situation, the weighted arm 16 is in a dynamic pseudo stationary state of motion. This process of revectoring is a dynamic method to focus and control the orientation of the unbalanced centrifugal forces in any chosen direction. By employing the source of unbalanced centrifugal forces produced by the arm 16, revectoring generates the unidirectional and propellantless propulsion force 36.

In other words, one function of the platform 22 is to steer the unbalanced centrifugal forces produced by the weighted arm 16 in one selected direction. The redirection of the centrifugal forces is achieved by superimposing the rotation of the platform 22 on the rotation of the arm 16. A dynamic process defined as revectoring. When both, the arm 16 and the platform 22 rotate with the same selected angular velocity in opposite directions; the weighted arm 16 rotates 360° in the direction 30; and the platform 22 will have rotated the thrust generator 12 through 360° in the opposite direction 32 simultaneously. In this fashion, the arm 16 always aims in the same direction. Consequently, the resultant unbalanced centrifugal forces produced with the arm 16 always act to one side of the inertial thrust drive 10; and always pointing in the same direction; the direction indicated with the vector of the propellantless propulsion force 36.

In the inertial thrust drive 10, the magnitude of the unbalanced centrifugal forces produced by the arm 16 is largely in proportion to the magnitude of the angular accelerations involved. In the platform 22, the centrifugal forces are in direct proportion to the mass, the radius of gyration about the axis 34, and the square of the platform 22 angular velocity. In contrast to the platform 22, for the arm 16, in addition to the mass and the weight 20 and the radius of gyration, the magnitude of the unbalanced centrifugal forces produced with the mass 20 also depends on the magnitude of the angular velocities in the rotational directions 30 and 32. The output of unbalanced centrifugal force by the weight 20 directly relates to the magnitude of the angular velocities of both, the velocity of the platform 22 in the direction 32, and the angular velocity of the arm 16 in the direction 30. In total, the weight 20 sees two angular velocities acting on it.

In reference to the angular velocities only, the magnitude of the unbalanced centrifugal forces produced by the weight 20 vary in proportion to angular velocities acting on it. In the first case, the torque of the motor 14 rotates the weighted arm 16 in the direction 30. In the second case, the weight 20 experiences the angular velocity related to the platform 22 gyration about the axis 34. In the platform 22, the weight 20 also experiences the effects attributed by superimposing the rotation of the platform 22 on the thrust generator 12. The torque of the motor 24, acts on the platform 22 to rotate the entire thrust generator 12 in the rotational direction 32. As a component of the thrust generator 12, the weight 20 located on a distal end of the arm 18 also undergoes the effects of the imputed gyration of the thrust generator 12 in the clockwise direction 32. In total, the sums of the gyratory angular velocities acting on the weight 20 are equal to the sums of the angular velocities in the directions 30 and 32. Thus as a result of revectoring, the total centrifugal thrust output that generates the unidirectional and propellantless propulsion force 36 is also proportional to the magnitudes of the gyratory angular velocities in the directions 30 and 32.

As the reader can see, the process of revectoring incorporates the relative motion between the frames of reference of the components involved in revectoring. Consequently, the synergy of revectoring comes as a result of superimposing the rotation of one frame of reference (the platform 22 rotating in one direction) on a second frame of reference (the arm 16 rotating in the opposite direction) that resides in the first (in the platform 22). While simultaneously, the second frame of reference (the weighted arm 16) independently rotates in the opposite direction. During revectoring, both frames of reference rotate with the same selected angular speed of rotation in opposite directions to generate the synergy of a third effect; an effect that focus the unbalanced centrifugal forces that generate the unidirectional propulsion force 36. While at the same time; revectoring also augment the output of the unbalanced centrifugal forces produced by the arm 16 due to the additive effect of the angular velocities involved.

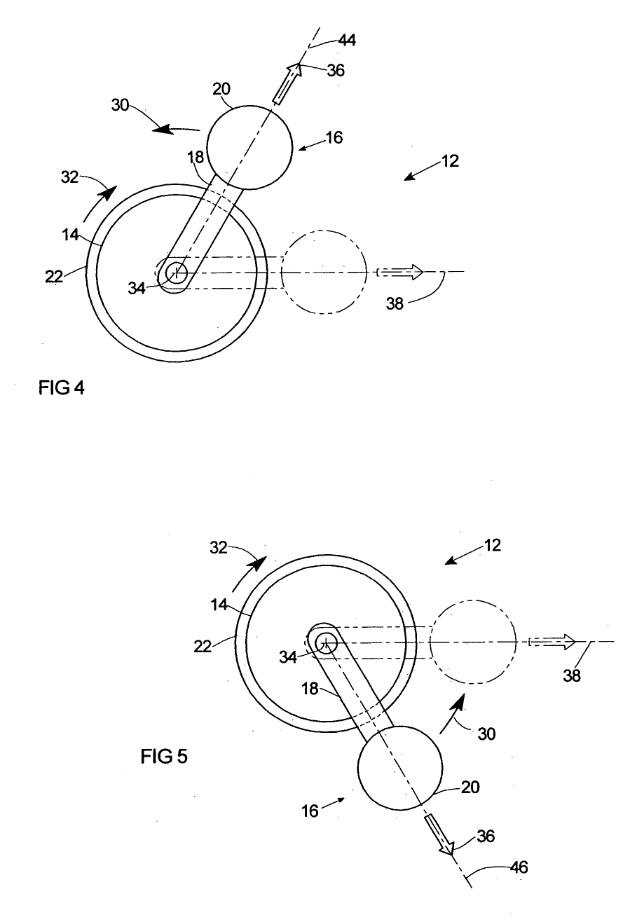

FIGS. 4 and 5 show another use of revectoring. In both cases, revectoring is employed to change the orientation of the propulsion force 36. A change in the direction of the propulsion force 36 can be accomplished with an angular velocity differential caused by varying the rotational velocity for either the arm 16 or the platform 22, or both. In both drawings, two axes 44 and 46 perpendicular to the axis 34 have been added. In FIG. 4, the arm 16 with the propulsion force 36 traversed from an initial position on the axis 38, shown with phantom lines, to a new arbitrary position marked with the axis 44. The weighted arm 16 can relocate to any position by varying the velocities of rotation in either direction 30 or 32. If the velocity of gyration for the platform 22 decreases; while the velocity of gyration for the arm 16 remains constant, the vector of the propulsion force 36 will continue rotating counterclockwise until both velocities of gyration even out. After the velocities of rotation for both the platform 22 and the arm 16 return to the same magnitude, the arm 16 will assume a new stationary vector position marked with the axis 44. The new stationary vector position for the propulsion force 36 will occur at the period of time and location when the angular velocities in both directions 30 and 32 become the same. Conversely, if the angular velocity for the platform 22 is kept constant; while at the same time the velocity for the arm 16 increases, the arm 16 will traverse to a new position on the axis 44 just as before. What's more, a similar vector translation can be obtained by varying the magnitudes of the corresponding angular velocity differentials in the directions 30 and 32 simultaneously.

Similarly, in FIG. 5, the propulsion force 36 shifts from the initial position on the axis 38 to a new arbitrary position marked with the axis 46. The arm 16 rotates to a new position by increasing the platform 22 speed of rotation while the speed for the arm 16 remains constant. Afterwards, both velocities of rotation return to the same magnitude in both directions 30 and 32. The force 36 vector then assumes a new stationary position on the axis 46. In both cases, the new vector position for the arm 16 can be maintained by equalizing the speed of rotation in both directions 30 and 32. The same force 36 vector translation can also become attainable by decreasing the arm 16 rotational velocity for a brief interval of time while the angular velocity for the platform 22 remains constant. Also, a simultaneous and corresponding change in both speeds of rotation generates a similar result.

An analysis of the procedure above shows that, the direction of the propulsion force 36 vector can change by employing a differential in the speed of rotation between the arm 16 and the platform 22. The in phase or the synchronized steady state of revectoring occurs when both, the weighted arm 16 and the platform 22 rotate with selected velocities of equal magnitude. The differential in the velocities of rotation between both, the arm 16 and the platform 22 can take the force 36 out of phase and out of synchronization with the revectoring process. As the rotational velocity differential induces the force 36 vector to steps out of phase with revectoring; the propulsion force 36 traverse to a new position in the plane of rotation. The new vector position for the force 36 depends on the magnitude of the velocity differential and the length of time the force 36 vector is out of phase with revectoring. As a result, a method to change the direction of the propulsion force 36 vector can be practiced.

In addition to the schematic embodiment shown in the illustrations herein, the motor 24 can also be placed in a transverse position in relation to the platform 22. In this particular embodiment, the functional connection between the platform 22 and the motor 24 can be done by way of gears, a gearbox, or a transmission in between with the corresponding support structure. Moreover, it is also possible to employ a gearbox or a transmission in the construction of an inertial thrust drive 10. Furthermore, the direction of the propulsion force 36 can also change by rotating the entire inertial thrust drive 10 in a selected direction. This last approach can be accomplished by adding the suitable and corresponding hardware for the task. Also, the gyroscopic effects are minimized by the counter rotation of the arm 16 and the platform 22; leaving alone the unbalanced centrifugal forces that generate the propulsion force 36.

As the examples above shows, the synergy of superimposing the rotational energy of the platform 22 on the centrifugal thrust generator 12 generates a new technology useful for the application of propellantless propulsion. To generate the propulsion force 36, the rotation of the weighted arm 16 generates unbalanced centrifugal forces in its plane of rotation. While simultaneously, the rotation of the platform 22 rotates the entire thrust generator 12 to keep the arm 16 pointing in one direction. Accordingly, the unbalanced centrifugal forces produced with the arm 16 also act in the same direction. The example in FIG. 4 and FIG. 5 shows that in addition, a rotation differential between the platform 22 and the arm 16 can be utilized to change the vector of the propulsion force 36 from one direction to another. As a dynamic process, revectoring is a method that provides a way to generate the propellantless thrust, and also a method to control and change the direction of the propellantless propulsion force 36.

In regards to the function of the platform 22, it provides a link between the motors 14 and 24; and operational and structural support for the motor 14. If necessary, the platform 22 can be eliminated by including the platform 22 function in the housing of the motor 14. Thus the shaft of the motor 24 would be directly connected to the housing of the motor 14.

As it relates to propulsion, there is an economy of energy that can be achieved with an inertial thrust drive 10. The economy of energy is due mainly to the low energy required to rotate a mass in an orbit of circular motion to produce unbalanced centrifugal forces. The energy and torque required can be considerably much less in comparison to other methods of propulsion. As the principles of the invention show, the synergy produced by superimposing two counter rotating operations in the manner disclosed in the invention above is a new approach in the field of propulsion. The principles of operation in an inertial thrust drive permit the construction of a prime mover unique and useful for propellantless propulsion.

### CONCLUSION, RAMIFICATIONS, AND SCOPE OF INVENTION

In the field of propulsion, an inertial thrust drive is a propellantless prime mover useful for the propulsion of land vehicles such as railway cars, passenger cars, trucks and vans. As the present state of economic activity shows, propulsion technology is a commodity. A ubiquitous commodity we use everyday. We don't think about it. And we take it for granted. The internal combustion engine with a drive train is the most successful and best selling propulsion system of all times. Millions of units are sold every year that consume many billion gallons of fuel and pollute the environment with the exhaust emission. The application of an inertial thrust drive for on land propulsion will eliminate the need of a drive train for propulsion. The removal of the drive train will yield an increment in the miles per gallons for each vehicle. While at the same time it will decrease the level of pollution produced by each engine.

In aviation, a propellantless inertial thrust drive is useful for the propulsion of aircrafts and related aerospace vehicles. As an added benefit, an inertial thrust drive can deliver a considerable reduction in fuel consumption that will increase the aerospace vehicle's performance with the added benefit of a reduction in the costs of operations. Another application relevant to aerospace is the development of new lift and thrust platforms based on the technology of inertial thrust drives. For example, a singular or several inertial thrust drive engines oriented vertically can be employed to generate propulsive levitation lift and vectored thrust for propulsion. In a horizontally position, an inertial thrust drive can provide vectored thrust for motion and direction control.

In the field of naval operations, an inertial thrust drive is useful as a ship propulsion engine. Instead of the traditional marine propeller, an inertial thrust drive can perform the task without the added turbulence and losses of propellers. In submarines, the elimination of the submarine propeller will yield a high considerable reduction in submarine noise, drag, and fuel consumption due to improved fuel economy and propulsion efficiency. In the field of space exploration, an inertial thrust drive has the advantage that no propellant is required for the propulsion of spacecrafts. In space travel, a self contained inertial thrust drive can operate with electric motors and electricity from the sun and the nearby stars, or from any onboard power plant. Furthermore, these same advantages also translate to the operation of satellites far out into space or in orbit around the earth and other planets.

The descriptions above contain many specificities and illustrations of some of the presently preferred embodiments. There are numerous variations, implied derivatives, and ramifications beyond those illustrated in the text. Thus the limit of the invention should be considered in the scope of the appended claims and their legal equivalents.

1. A device for obtaining a directional force from a rotary motion comprising a first motor, a weighted arm on the shaft of said motor, said motor gyrate said arm to generate unbalanced centrifugal forces in its plane of rotation, a second motor, the first motor connected to the second motor, the second motor rotates the assembly of the first motor with said arm at a selected angular speed to direct said unbalanced centrifugal forces in one direction, whereby said directed centrifugal forces generate a directional propulsion force.

2. A device for obtaining a directional force from a rotary motion comprising a first motor, a weighted arm on the shaft of said motor, said motor gyrate said arm to generate unbalanced centrifugal forces in its plane of rotation, a second motor, the first motor connected to the second motor, the second motor rotates the assembly of the first motor with said arm at a selected angular speed to direct said unbalanced centrifugal forces in one direction, a support frame, whereby said directed centrifugal forces generate a directional propulsion force.

3. The device in claim 2 producing a differential in the velocities of rotation between said motors and said arm to change the direction of the propulsion force.

4. A device for obtaining a directional force from rotary motion comprising, providing means to generate unbalanced centrifugal forces, providing means of rotary energy, whereby superimposing said rotary energy on said means of centrifugal forces at a selected angular speed direct said unbalanced centrifugal forces in one direction, whereby said directed centrifugal forces generate a directional propulsion force.

5. A device for obtaining a directional force from rotary motion comprising, providing means to generate unbalanced centrifugal forces, providing means of rotary energy,
providing a support frame,
whereby said rotary energy means rotates said source of centrifugal forces at a selected angular speed to direct said unbalanced centrifugal forces in one direction, whereby said directed centrifugal forces generate a directional propulsion force.

6. The device in claim 5 providing a change in the direction of said propulsion force.

7. Revectoring.

8. Revectoring comprising:
providing means to generate centrifugal forces,
providing means of rotary energy,
whereby superimposing rotary energy on said means of centrifugal forces generate a directional propulsion force.

9. Revectoring comprising:
providing a support frame,
providing means to generate centrifugal forces,
providing means of rotary energy,
whereby superimposing rotary energy on said means of centrifugal force generates a directional propulsion force

10. Revectoring comprising:
providing a support frame,
providing means to generate centrifugal forces,
providing means of rotary energy,
providing means to change the direction of the propulsion force,
whereby superimposing rotary energy on said means of centrifugal force generates a directional propulsion force.

11. The process in claim 7 comprising:
providing a support frame,
providing means to generate centrifugal forces,
providing means of rotary energy,
whereby superimposing rotary energy on said means of centrifugal force generates a directional propulsion force

12. The process in claim 7 comprising:
providing a support frame,
providing means to generate centrifugal forces,
providing means of rotary energy,
providing means to change the direction of the propulsion force,
whereby superimposing rotary energy on said means of centrifugal force generates a directional propulsion force.
